(19) United States
(12) Patent Application Publication
(10) Pub. No.: US 2026/0332588 A1
(43) Pub. Date: Oct. 22, 2026

(54) SYSTEMS AND METHODS FOR IDENTITY VERIFICATION

(71) Applicant: SUREPASS ID INC., Littleton, CO (US)

(72) Inventors: Murphy Robinson, Littleton, CO (US); Alex Robinson, Littleton, CO (US)

(21) Appl. No.: 19/652,744

(22) Filed: Apr. 20, 2026

Related U.S. Application Data
(60) Provisional application No. 63/791,132, filed on Apr. 18, 2025.

(51) Int. Cl. H04L 9/40

(52) U.S. Cl. CPC H04L 63/0876

(57) ABSTRACT

Methods and systems for identity verification are disclosed. A server associated with an identity verification service receives encoded data indicative of a unique identifier corresponding to a user from a verification device. Based on decoding the encoded data, the unique identifier corresponding to the user is compared to a plurality of verified identifiers stored in at least one database. The plurality of verified identifiers are associated with at least one entity that subscribes to the identity verification service. Display of a message indicating that an identity of the user is verified is caused via an interface of the verification device in response to determining that the unique identifier matches a verified identifier of the plurality of verified identifiers stored in the at least one database.

### CROSS-REFERENCE TO RELATED APPLICATIONS

This application claims priority to and is a non-provisional of U.S. Provisional Application No. 63/791,132, filed Apr. 18, 2025, which is incorporated by reference in its entirety as if fully set forth herein.

### BACKGROUND

An entity (e.g., company, organization, individual, consumer, etc.) may want to verify the identity and/or other identifying information (e.g., name, title, rank, badge number, employer, photo, etc.) of its members or employees and/or may want to verify the official capacity of an individual within another company, such as a company that the entity is receiving services from. For example, the entity may wish to confirm that an individual is indeed a member or employee of that entity before granting the individual access to certain premises (e.g., areas) associated with the entity and/or to restricted areas. It is important that such an identity verification process is both accurate and efficient.

### SUMMARY

Methods, systems, and devices for identity verification are disclosed. Encoded data indicative of a unique identifier corresponding to a user is received. The encoded data represents encrypted and signed unique identifiers. The encoded data is received from a verification device and by at least one server associated with an identity verification service. The unique identifier corresponding to the user is compared to a plurality of verified identifiers stored in at least one database. The unique identifier corresponding to the user is compared to the plurality of verified identifiers based on the at least one server decoding and decrypting the encoded data. Each of the plurality of verified identifiers is associated with at least one entity. At least a subset of the plurality of verified identifiers are stored in the at least one database in response to the at least one entity subscribing to the identity verification service. Display of a message indicating that the identity of the user is verified is displayed in response to determining that the unique identifier matches a verified identifier of the plurality of verified identifiers stored in the at least one database. The message is displayed via an interface of the verification device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is an example system for identity verification, according to an illustrative embodiment;

FIG. 2 is an example method for identity verification, according to an illustrative embodiment;

FIG. 3 is an example user interface of an identity verification application, according to an illustrative embodiment;

FIG. 4 is an example user interface of an identity verification application, according to an illustrative embodiment;

FIG. 5 is an example user interface of an identity verification application, according to an illustrative embodiment;

FIG. 6 is an example user interface of an identity verification application, according to an illustrative embodiment;

FIG. 7 is an example method for identity verification, according to an illustrative embodiment;

FIG. 8 is an example method for self-verification, according to an illustrative embodiment;

FIG. 9 is an example computing device, according to an illustrative embodiment;

### DETAILED DESCRIPTION

A fraudulent actor may attempt to impersonate an individual associated with an entity (e.g., a governmental entity, a business, a non-profit or for-profit organization, an institution, etc.) to gain access to a restricted area and/or a consumer-controlled private area (e.g., private property of the consumer). For example, a fraudulent actor may attempt to impersonate a law enforcement officer to gain entry to a building, venue, or other premises. As another example, a fraudulent actor may attempt to impersonate an employee of a company to gain access to the workplaces(s) of the company. If such fraudulent actors are successful in their impersonation attempts, this can not only damage the reputation and well-being of the entity, but it can also pose a risk to individuals who do not belong to the entity (e.g., in the case of a fraudulent actor with a weapon that impersonates a law enforcement officer to gain entry to a busy entertainment venue).

To prevent fraudulent actors from successfully impersonating other individuals, credentials associated with those entering restricted areas can be inspected. For example, individuals may be required to show their police badge or their employee ID to a security official to gain access to a restricted area. However, this manual verification process is prone to human error. Further, this manual verification process does not enable the automatic creation of a digital log that shows who has accessed a restricted area and when each of those individuals have accessed the restricted area. As such, improved techniques for identity verification are needed.

Described herein are improved techniques for identity verification. An entity can sign up for (e.g., subscribe to) an identity verification service. The entity can provide the identity verification service with data indicating verified individuals associated with the entity. Such data (e.g., verification data) can indicate an identification code associated with each of the verified individuals and/or facial feature data (e.g., one or more photos) associated with each of the verified individuals. The identity verification service can maintain (e.g., store) the verification data in one or more databases. The identity verification service can periodically refresh (e.g., update) the stored verification data so that it accurately reflects the verified individuals associated with the entity. Further, the entity can create one or more rules to be used by the identity verification service. The rule(s) can indicate, for each of the verified individuals, one or more premises (e.g., locations) that the individual is allowed to access. Different individuals may be allowed to access different premises. The identity verification service can maintain data indicating the rule(s) in the database(s) and can refresh such rule data as it is updated by the entity.

The identity verification service can utilize the stored verification data and/or the stored rule data to verify an individual’s identity before allowing them to access a restricted area. For example, a user may present a credential (e.g., a Near Field Communication (NFC) card or an NFC pass) to a security official located at the restricted area. The credential may store encoded data indicative of a unique identifier corresponding to the user. The security official may be equipped with a verification device. An application associated with the identity verification service can be executing on the verification device. The security official may scan the credential using the application.

In response to the credential being scanned, the verification device can send the encoded data indicative of the unique identifier corresponding to the user to one or more servers associated with the identity verification service. The server(s) can decode the encoded data indicative of the unique identifier. The server(s) can compare the decoded data to the stored verification data to determine if the unique identifier matches the verification data corresponding to any of the verified individuals. If the unique identifier does match (e.g., correspond to) the verification data corresponding to one of the verified individuals, the server(s) can determine that the user is a verified individual. If the server(s) determine that the user is a verified individual, the server(s) can optionally determine, based on the rule data, if the user is allowed to access this particular restricted area.

The server(s) can send data indicating that the user is a verified individual to the verification device. The server(s) can send the data indicating that the user is a verified individual based on determining that the user is a verified individual and/or that the user is allowed to access this particular restricted area. The verification device can receive the data indicating that the user is a verified individual. In response to receiving the data, the verification device can cause display of a message indicating that the user is a verified individual via an interface of the application. The security official may allow the user to enter the restricted area based on display of the message.

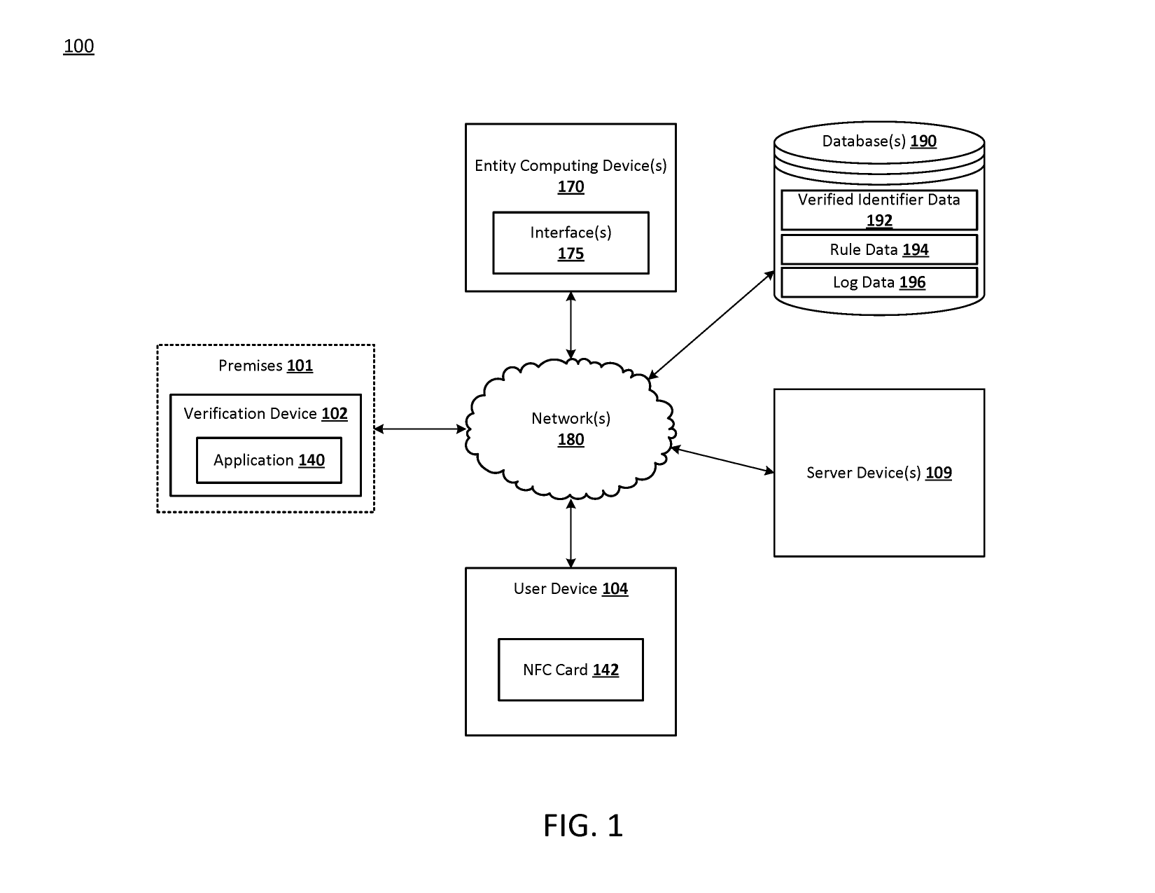

FIG. 1 shows a block diagram of an example system 100. The system 100 includes at least one user device 104, one or more server devices 109, one or more databases 190, one or more entity computing devices 170, and verification device 102. It should be noted that while the singular terms service and device are used herein, it is contemplated that some services and devices may be implemented as a single device or a plurality of devices (e.g., via load balancing). The one user device 104, one or more server devices 109, one or more databases 190, one or more entity computing devices 170, and the verification device 102 may each be implemented as one or more computing devices. Any device disclosed herein may be implemented using one or more computing nodes, such as virtual machines, executed on a single device and/or multiple devices.

The user device 104, the server device(s) 109, the database(s) 190, the entity computing device(s) 170, and the verification device 102 may be configured to communicate via one or more networks, such as a network 180. The network 180 may comprise any of a variety of types of networks, such as, for example, a coaxial cable network, a fiber-optic cable network, a hybrid fiber-coaxial (HFC) network, a satellite transmission channel, a DSL connection, or the like. The network 180 may comprise fiber, cable, a combination thereof. The network 180 may comprise one or more wired links, wireless links, a combination thereof, and/or the like. The network 180 may comprise one or more routers, switches, nodes, gateways, servers, modems, and/or the like. The network 180 may comprise one or more networks, such as a wide area network (e.g., the Internet), a cellular network, a Long Term Evolution (LTE) network, one or more service entity networks, and/or the like.

The user device 104, the entity computing device(s) 170, and the verification device 102 may each comprise a computing device, a smart device (e.g., smart glasses, smart watch, smart phone), a wearable computing device, a mobile device, a telephone, a tablet, a computing station, a laptop, a digital streaming device, and/or the like. The entity computing device(s) 170 may comprise one or more computing devices associated with an entity. The entity may comprise, for example, a governmental entity, a business, a non-profit or for-profit organization, an institution, and/or the like.

To prevent fraudulent actors from impersonating individuals associated with the entity, the entity may subscribe to an identity verification service. To subscribe to the identity verification service, the entity can provide the identity verification service with data indicating verified (e.g., official) individuals associated with the entity. For example, the entity can send (via the entity computing device(s) 170) the data indicating the verified (e.g., official) individuals associated with the entity to the server(s) 109 associated with the identity verification service. Such data can include a unique identification code (e.g., alphanumeric code, etc.) associated with each of the verified individuals and/or unique facial feature data (e.g., one or more photos) associated with each of the verified individuals. Such data can include title information, rank information, or agency information associated with each of the verified individuals.

The server(s) 109 can receive the verification data. The server(s) 109 can maintain (e.g., store) the verification data in the database(s) 190 as verified identifier data 192. The identity verification service can periodically refresh (e.g., update) the verified identifier data 192 so that it accurately reflects the verified individuals associated with the entity. To periodically refresh (e.g., update) the verified identifier data 192 so that it accurately reflects the verified individuals currently associated with the entity, the server(s) 109 can ping (e.g., send a message to) the entity, such as to the entity computing device(s) 170. The entity can receive the message. In response to receiving the message, the entity can send a response verifying that the verified identifier data 192 is current and/or can send a response including updates to the verified identifier data 192. The server(s) can update the verified identifier data 192 based on the response received from the entity.

In embodiments, the entity can create one or more rules to be used by the identity verification service. The rule(s) can indicate, for each of the verified individuals, one or more premises (e.g., locations) that the individual is allowed to access. Different individuals may be allowed to access different premises. For example, a first individual associated with a first unique identification code may be allowed to access a first premises, while a first individual associated with a second unique identification code may be allowed to access a second premises, but not a first premises. The entity can provide the identity verification service with data indicating the rule(s). For example, the entity can send (via the entity computing device(s) 170) the rule data.

The server(s) 109 can receive the rule data. The server(s) 109 can maintain (e.g., store) the verification data in the database(s) 190 as rule data 194. The identity verification service can periodically refresh (e.g., update) the rule data 194 so that it accurately reflects the rule(s) created by the entity. To periodically refresh (e.g., update) the rule data 194 so that it accurately reflects the rule(s) created by the entity, the server(s) 109 can ping (e.g., send a message to) the entity, such as to the entity computing device(s) 170. The entity can receive the message. In response to receiving the message, the entity can send a response verifying that the rule data 194 is current and/or can send a response including updates to the rule data 194. The server(s) can update the rule data 194 based on the response received from the entity.

In embodiments, in addition to, or as an alternative to, the server(s) 109 receiving the verification data from the entity, one or more individuals can self-verify as being associated with the entity. A user associated with the user device 104 can self-verify as being associated with the entity. To self-verify as being associated with the entity, the user can use the user device 104 to scan a quick-response (QR) code associated with the identity verification service. The QR code may be displayed via a different device, such as via an interface of the verification device 102. As an example, the QR code may be displayed via an application 140 executed on (e.g., installed on) the verification device 102. The application 140 can be associated with the identity verification service. Based on (e.g., in response to) the user scanning the QR code, the user can be prompted to enter information associated with the user. The information associated with the user can include one or more of a name, entity name, entity email address, a photograph, and/or the like.

For example, a prompt to enter the user information can be displayed via an interface of the user device 104. The user can enter the information via the interface. Data indicating the user information can be sent, by the user device 104, to the server device(s) 109.

The server(s) 109 can receive the data indicating the user information. The server(s) 109 can determine, based on the data, if the email address entered by the user corresponds to an email domain of the entity. If the email address corresponds to an email domain of the entity, the server(s) 109 can create a unique identifier (e.g., a unique identification code (e.g., alphanumeric code, etc.) and/or unique facial feature data (e.g., one or more photos)), associated with the user indicating the user interaction with the registration form. The server(s) 109 can add the unique identifier to the verified identifier data 192. The server(s) 109 can send a verification email to the email address. The verification email can indicate, to the user, that the user is verified. The verification email can include instructions for logging into the verification services and/or instructions for accessing the credentials of the user.

Once the unique identifier associated with the user has been added to the verified identifier data 192 (either via self-verification, or in response to verification data received from the entity), the identity verification service can notify the entity that a new self-registration has been added. The identity verification service can prompt the entity to verify the data. Optionally, if the data is not verified by the entity within a specified time frame, the user verification can be revoked, and the user must reach out the entity to be added to the verification service.

The identity verification service can utilize the verified identifier data 192 to verify the identity of the user before allowing the user to access a restricted area, such as the premises 101. For example, the user may present a credential (e.g., a Near Field Communication (NFC) card 142 installed on the user device 104 or an NFC pass) to a security official located at the premises 101. The credential may store encoded data indicative of the unique identifier associated with the user. The security official located at the premises 101 may be equipped with a verification device 102. The application 140 associated with the identity verification service can be executing on the verification device 102. The application 140 can be configured to read the encoded data stored on the NFC card or the NFC pass and send the encoded data to the server(s) 109.

The security official (or an officer or consumer) may scan the credential using the application 140. In response to the credential being scanned, the verification device 102 can read the encoded data indicative of the unique identifier corresponding to the user and send the encoded data to the server(s) 109 associated with the identity verification service. The server(s) 109 can decode the encoded data indicative of the unique identifier. The server(s) 109 can compare the decoded data to the verified identifier data 192 to determine if the unique identifier matches a unique identifier corresponding to any of the verified individuals. If the unique identifier does not match (e.g., correspond to) the unique identifier corresponding to any of the verified individuals, the server(s) 109 can determine that the user is not a verified individual. Conversely, if the unique identifier does match (e.g., correspond to) the unique identifier corresponding to a verified individual (e.g., an individual verified by the entity), the server(s) 109 can determine that the user is the verified individual.

If the server(s) 109 determine that the user is the verified individual, the server(s) can optionally determine, based on the rule data 194, if the user is allowed to access the premises 10a. For example, the rule data 194 can indicate that the user is allowed to access the premises 101, but not a different premises. If the rule data 194 indicates that the user is allowed to access the premises 101, the server(s) 109 can determine that the user is allowed to access the premises 101. Conversely, if the rule data 194 indicates that the user is not allowed to access the premises 101, the server(s) 109 can determine that the user, despite being a verified individual, is not allowed to access the premises 101.

If the server(s) 109 determines that the user is not a verified individual and/or that the user is not allowed to access the premises 101, the server(s) 109 can send data, to the verification device 102, indicating that the user is denied entry to the premises 101. The verification device 102 can receive the data indicating that the user is denied entry to the premises 101. In response to receiving the data indicating that the user is denied entry to the premises 101, the verification device 102 can cause display of a message indicating that the user is denied entry to the premises 101 via an interface of the application 140. The security official (or the officer or consumer) may deny the user entry the premises 101 based on display of the message.

If the server(s) 109 determines that the user is a verified individual and/or that the user is allowed to access the premises 101, the server(s) 109 can send data indicating that the user is a verified individual to the verification device 102. The verification device 102 can receive the data indicating that the user is a verified individual. In response to receiving the data, the verification device 102 can cause display of a message indicating that the user is a verified individual via an interface of the application 140. The security official (or the officer or consumer) may allow the user to enter the premises 101 based on display of the message. In embodiments, causing display of the message indicating that the user is a verified individual can include causing display of an image of the user, a name of the user, and/or a title of the user within the entity. The security official (or the officer or consumer) may be prompted, via the interface of the application 140, to verify that the user looks like the image.

In embodiments, the verification device 102 can cause display, via an interface of the application 140, of at least one user interface element that is selectable to provide additional information about the user. The user interface element(s) can be displayed based on (e.g., in response to) receiving the data indicating that the user is a verified individual. The user interface element(s) and the message indicating that the user is a verified individual can be simultaneously displayed via the interface of the application 140. As one example, the additional information can indicate if the user is armed or unarmed. As another example, the additional information can indicate if why the user is attempting to enter the premises 101. It should be appreciated that the additional information can include any other information about the user that can be provided by the security official (or the officer or consumer). If the security official (or the officer or consumer) provides the additional information about the user (e.g., selects the user interface element(s)), data indicating the additional information about the user can be sent by the verification device 102 to the server(s) 109. The server(s) 109 can receive the data indicating the additional information about the user.

In embodiments, the server(s) 109 can create a digital log (e.g., log data 196) indicating which verified individuals have entered which restricted areas and at what time. For example, in response to determining that the user is a verified individual and/or that the user is allowed to access the premises 101, the server(s) 109 can automatically update the log data 196 stored in the database(s) 190. For example, the server(s) 109 can automatically add information indicating that the user corresponding to the unique identity has entered premises 101 at a certain time (e.g., the time at which the server(s) 109 received the encoded data indicative of the unique identifier associated with the user). The server(s) 109 can further cause storage of the additional information about the user in the digital log. This log data 196 can be automatically updated each time a verified individual enters a restricted area.

The entity, or one or more privileged users (e.g., administrators) associated with the entity, can view the digital log via the entity computing device(s) 170. For example, one or more privileged users (e.g., administrators) associated with the entity can use the entity computing device(s) 170 to log into a web portal associated with the identity verification service. The digital log associated with the entity can be displayed via an interface 175 of the entity computing device(s) 170. In this manner, the entity can easily track who is entering restricted areas, when they are entering restricted areas, and why they are entering restricted areas.

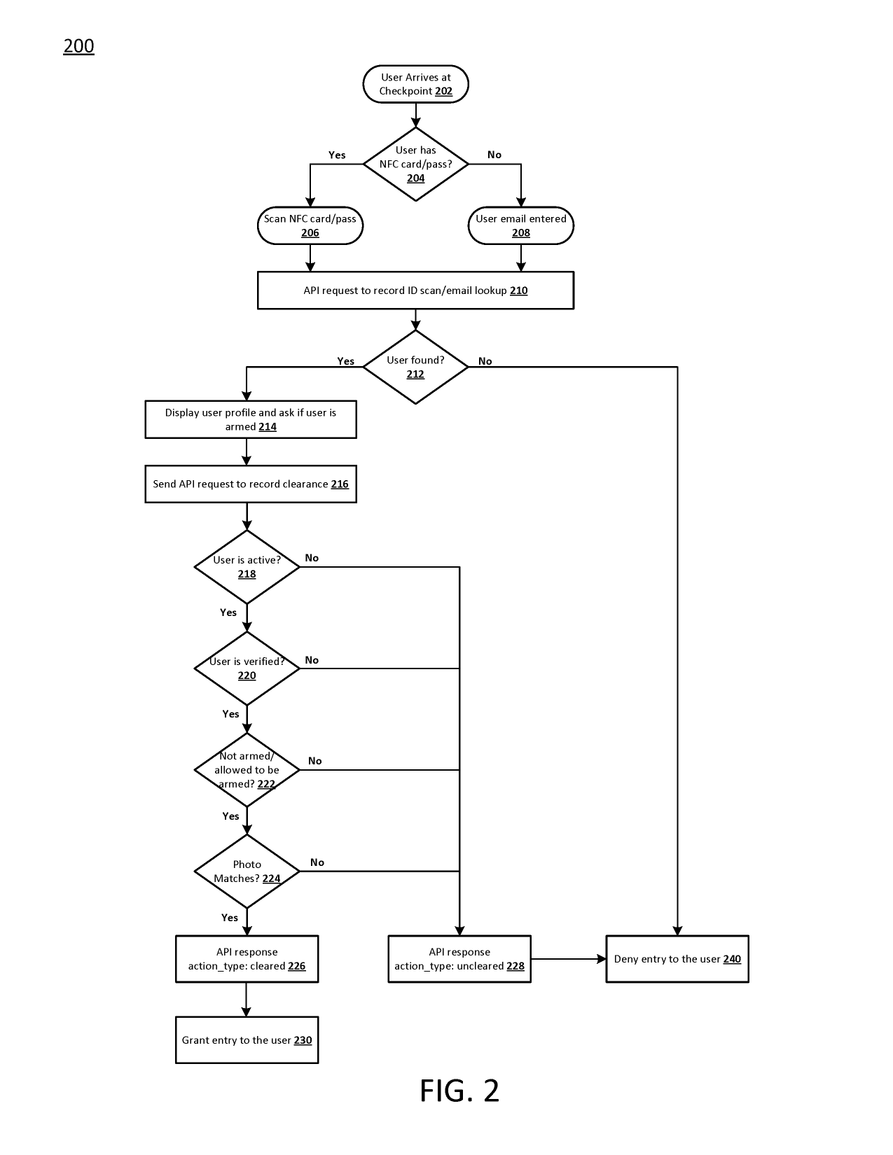

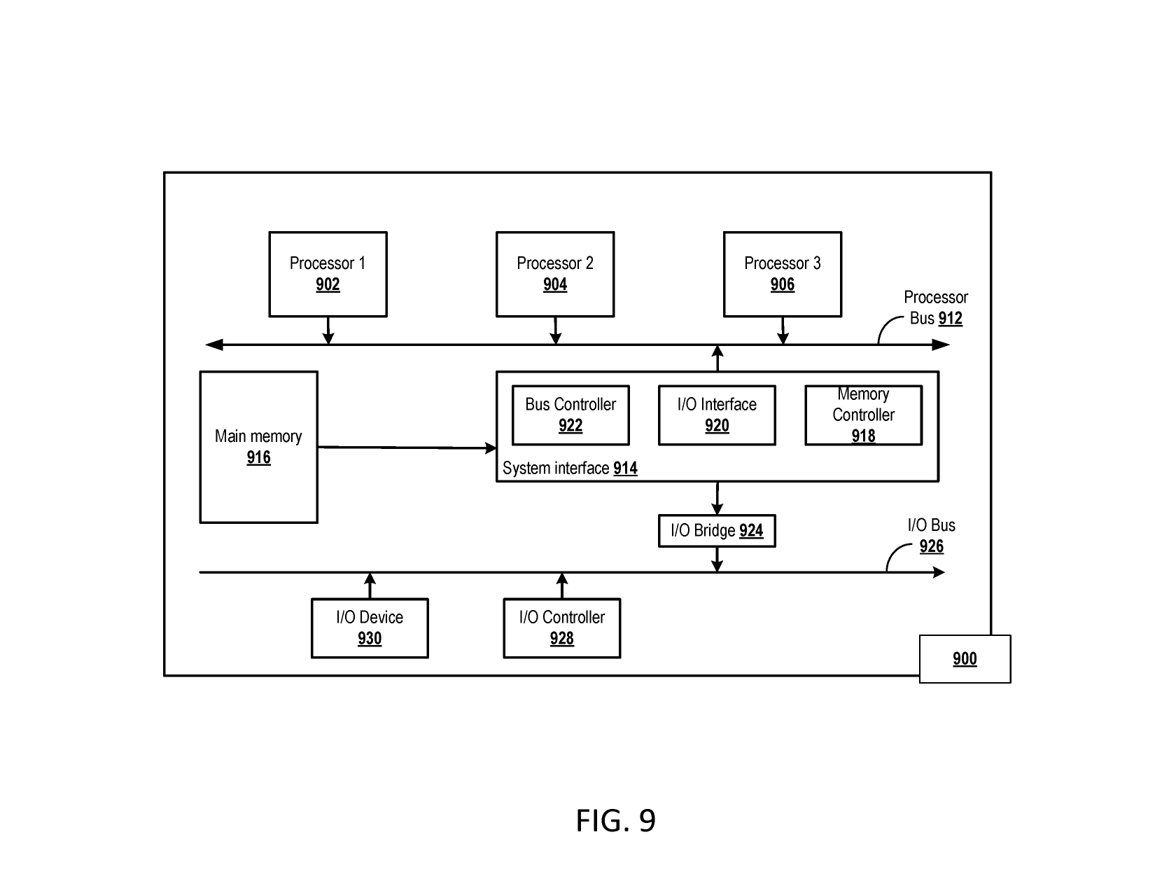

FIG. 2 is an example method 200. The method 200 may comprise a computer implemented method for identity verification. A system and/or computing environment, such as the system 100 of FIG. 1 and/or the computing environment of FIG. 9, may be configured to perform the method 200.

At 202, a user can arrive at a security checkpoint (e.g., at a premises). At 204, it can be determined if the user has a credential (e.g., a Near Field Communication (NFC) card or an NFC pass) associated with an entity that subscribes to an identity verification service. The credential can store encoded data indicative of a unique identifier corresponding to the user.

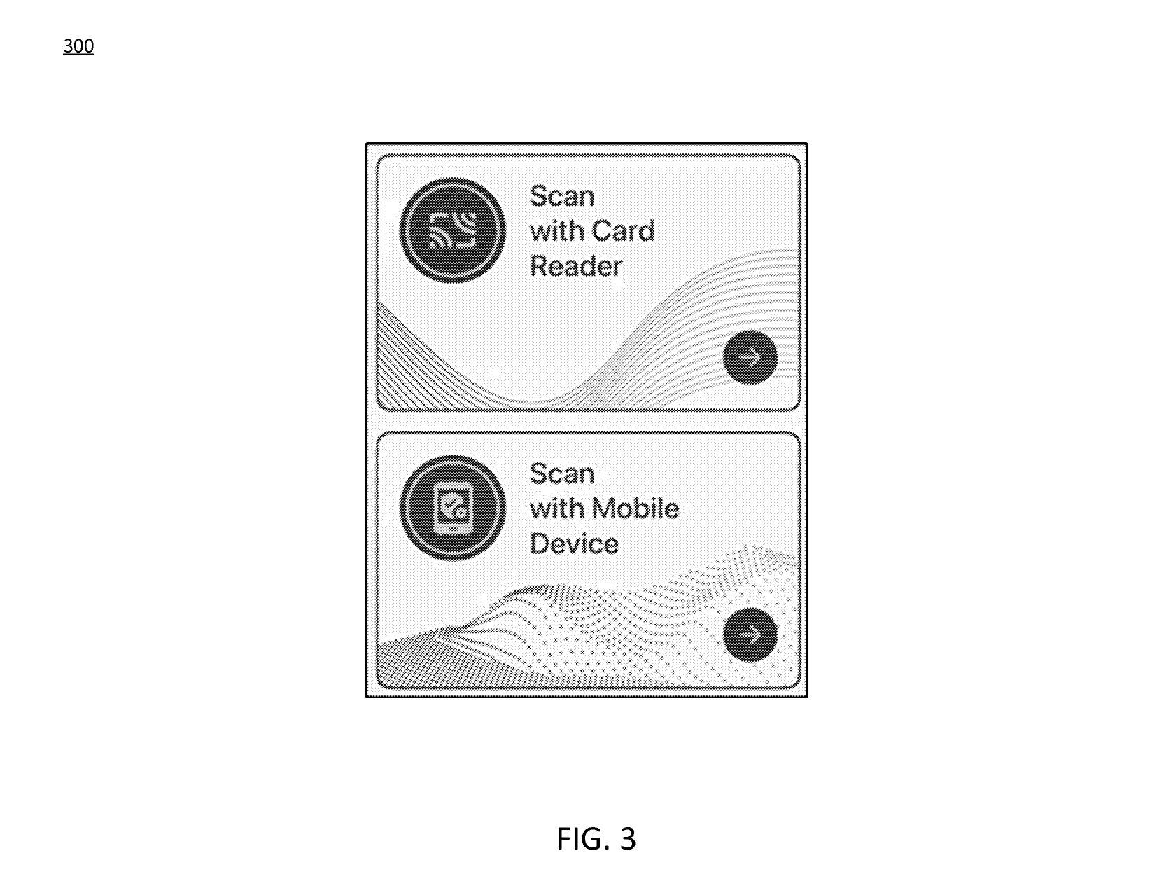

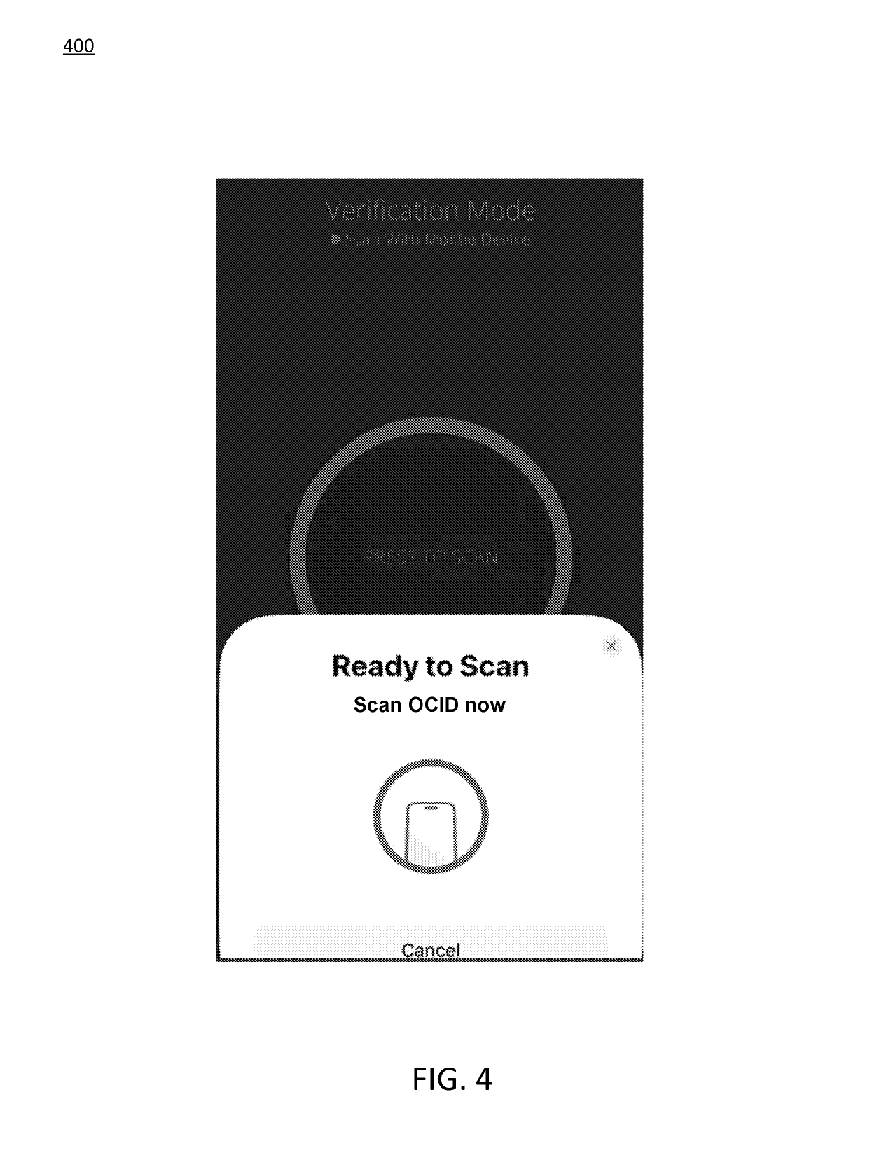

If the user does have a credential associated with an entity that subscribes to an identity verification service, the method 200 can proceed to 206. At 206, the credential can be scanned using an application (e.g., application 140) associated with the identity verification service. The application can be installed on a verification device (e.g., verification device 102). FIG. 3 shows an example user interface 300 of the application. As shown in FIG. 3, a security official (or the officer or consumer) may initiate the scan by selecting “scan with card reader” if the user has an NFC card. Alternatively, the security official may initiate the scan by selecting “scan with mobile device” if the user has an NFC pass. After the security official initiates the scan, as shown in the example user interface 400 of FIG. 4, the security official can be prompted to scan the credential. The security official can scan the credential and the method 200 can proceed to 210. If the user does not have a credential associated with an entity that subscribes to an identity verification service, the method 200 can instead proceed to 208. At 208, an email address of the user can be entered. For example, the security official can ask the user for the user’s email address, and the security official can enter the email address into the application. The method 200 can proceed to 210.

At 210, the verification device can send an Application Programming Interface (API) request to a server (server(s) 109) associated with the identity verification server. The API request may comprise a request to record the credential scan or email lookup. At 212, the server(s) can determine if a verified user, as indicated by the verified identifier data 192, matches the scanned credential or email. If a verified user does not match the scanned credential or email, the method 200 can proceed to 240. Conversely, if a verified user matches the scanned credential or email, the server(s) can send data indicating that the user is a verified individual to the verification device and the method 200 can proceed to 214.

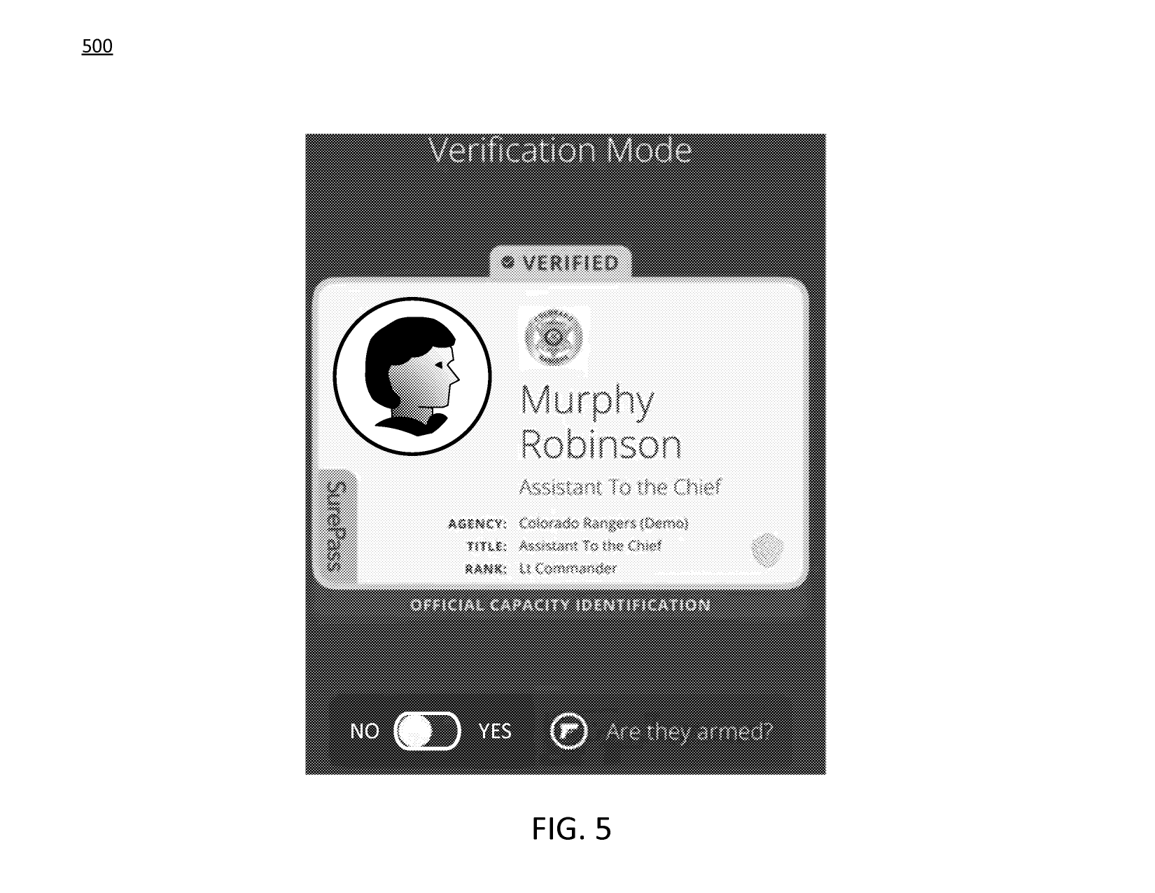

At 214, the verification device can cause display, via an interface of the application, of profile associated with the user. The profile can include an image of the user, a name of the user, and/or a title of the user within the entity. An example profile is shown in the user interface 500 of FIG. 5. As shown in FIG. 5, the verification device can also cause display of at least one user interface element that is selectable to provide additional information about the user. As one example, the additional information can indicate if the user is armed or unarmed. If the security official provides the additional information about the user (e.g., selects the user interface element(s)), data indicating the additional information about the user can be sent by the verification device to the server(s). The server(s) can receive the data indicating the additional information about the user.

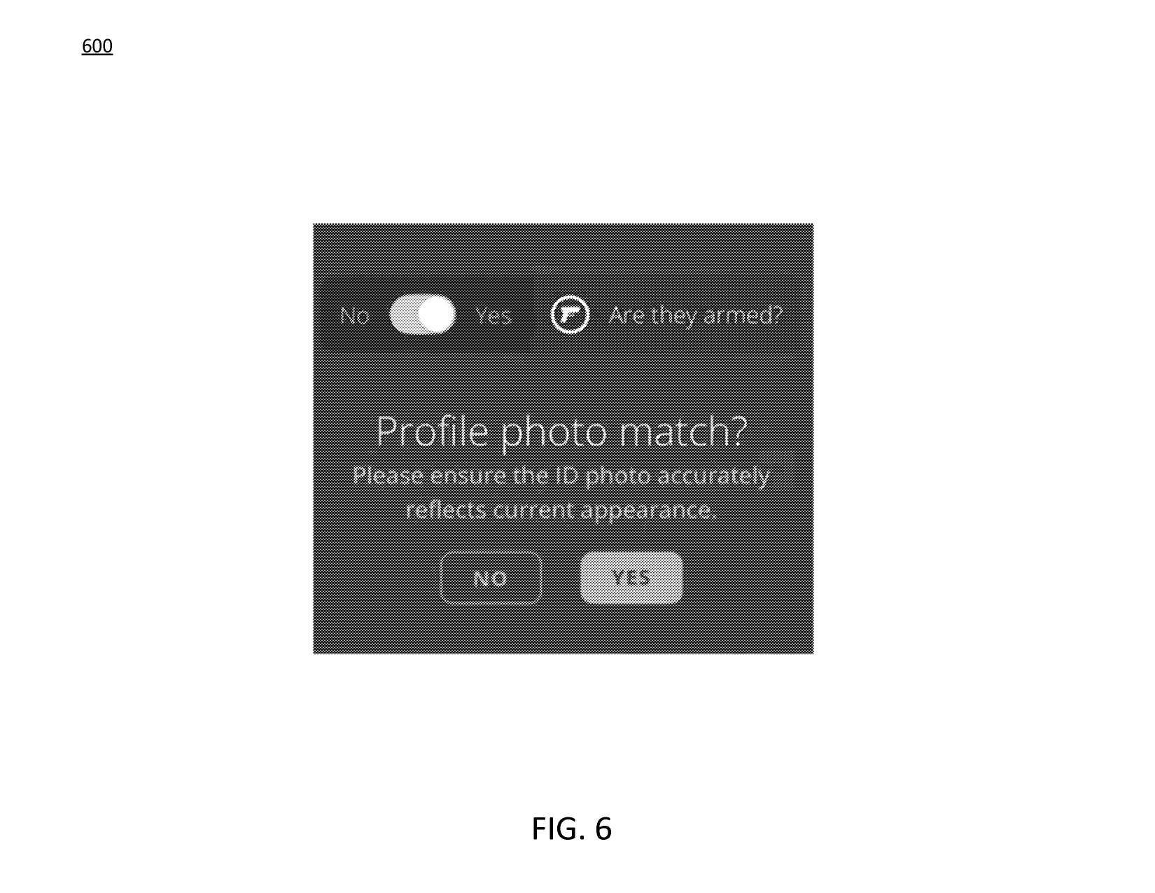

At 216, the verification device can send an API request to record clearance (e.g., give the user access to the premises). The verification device can send the API request to the server(s). At 218, the server(s) can determine if the user is active (e.g., actively employed by the entity, or currently associated with the entity). If the user is not active, the method 200 can proceed to 228. If the user is active, the method 200 can proceed to 220. At 220, the server(s) can determine if the user is verified. For example, it can be determined if the user is authorized to enter the premises based on one or more rules created by the entity. If the user is not verified, the method 200 can proceed to 228. If the user is verified, the method 200 can proceed to 222. At 222, the server(s) can determine if the user is allowed to be armed if the security official indicated that the user is armed. If the user is not armed, but not allowed to be armed, the method 200 can proceed to 228. If the user is not armed or if the user is armed and allowed to be armed, the method 200 can proceed to 224. At 224, the security official can be prompted to verify if the user matches the photo in the profile. An example prompt 600 is shown in FIG. 6. If input from the security official indicates that the user does not match the photo in the profile, the method 200 can proceed to 228. If input from the security official indicates that the user does match the photo in the profile, the method 200 can proceed to 226.

At 226, the verification device can receive an API response. The API response can indicate that the clearance is recorded. At 230, the user can be granted entry to the premises. Conversely, at 228, the verification device can receive an API response indicating that the clearance is not recorded (e.g., uncleared). The method 200 can proceed to 240, where the user can be denied entry to the premises.

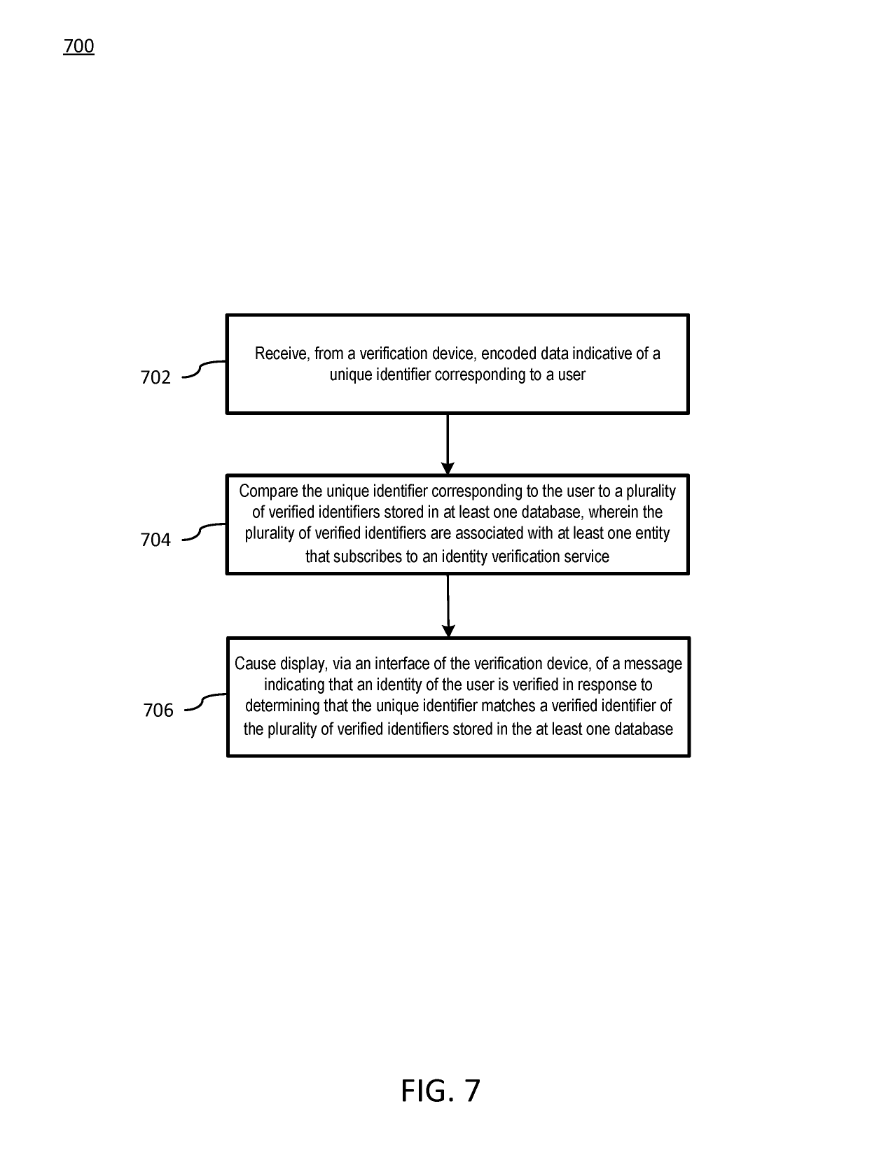

FIG. 7 is an example method 700. The method 700 may comprise a computer implemented method for identity verification. A system and/or computing environment, such as the system 100 of FIG. 1 and/or the computing environment of FIG. 9, may be configured to perform the method 700.

At 702, encoded data can be received. The encoded data can be received from a verification device. The verification device can be located at a premises (e.g., restricted area). The encoded data can be received by at least one server associated with an identity verification service. The encoded data indicative of the unique identifier can be received at a time. The encoded data can be indicative of a unique identifier corresponding to a user. The unique identifier can include at least one of an alphanumeric code corresponding to the user or data indicating facial features of the user. Receiving the encoded data indicative of the unique identifier corresponding to the user can include receiving the encoded data from an application executing on the verification device. The application can be associated with the identity verification service. The encoded data can be stored on a Near Field Communication (NFC) card or an NFC pass. The application can be configured to read the encoded data stored on the NFC card or the NFC pass and send the encoded data to the at least one server.

At 704, the unique identifier corresponding to the user can be compared to a plurality of verified identifiers stored in at least one database. The plurality of verified identifiers can be associated with at least one entity that subscribes to the identity verification service. At least a subset of the plurality of verified identifiers can be stored in the at least one database in response to the at least one entity subscribing to the identity verification service. Additionally, or alternatively, at least a subset of the plurality of verified identifiers can be stored in the at least one database in response to the one or more users self-verifying. Each of the plurality of verified identifiers stored in at least one database can include at least one of a unique alphanumeric code or facial feature data unique to one of a plurality of users.

At 706, display of a message indicating that an identity of the user is verified can be caused in response to determining that the unique identifier matches a verified identifier of the plurality of verified identifiers stored in the at least one database. The message can be caused to be displayed via an interface of the verification device. Causing display of the message indicating that the identity of the user is verified can include sending data, to the verification device, indicating that the identity of the user is verified. Causing display of the message indicating that the identity of the user is verified comprises causing display of at least one of an image of the user or information indicating a title of the user within the at least one entity.

In embodiments, a digital log can be created in the at least one database. The digital log can indicate that the user is located at the premises at the time. The digital log can be automatically created or updated in response to determining that the unique identifier matches the verified identifier. Display of information associated with the digital log can be caused via an interface of at least one computing device that is associated with a privileged user associated with the entity. Based on determining that the unique identifier matches the verified identifier, display of at least one user interface element that is selectable to provide additional information about the user can be caused. Based on user selection of the at least one user interface element, additional information about the user can be received. The additional information can be stored in the digital log.

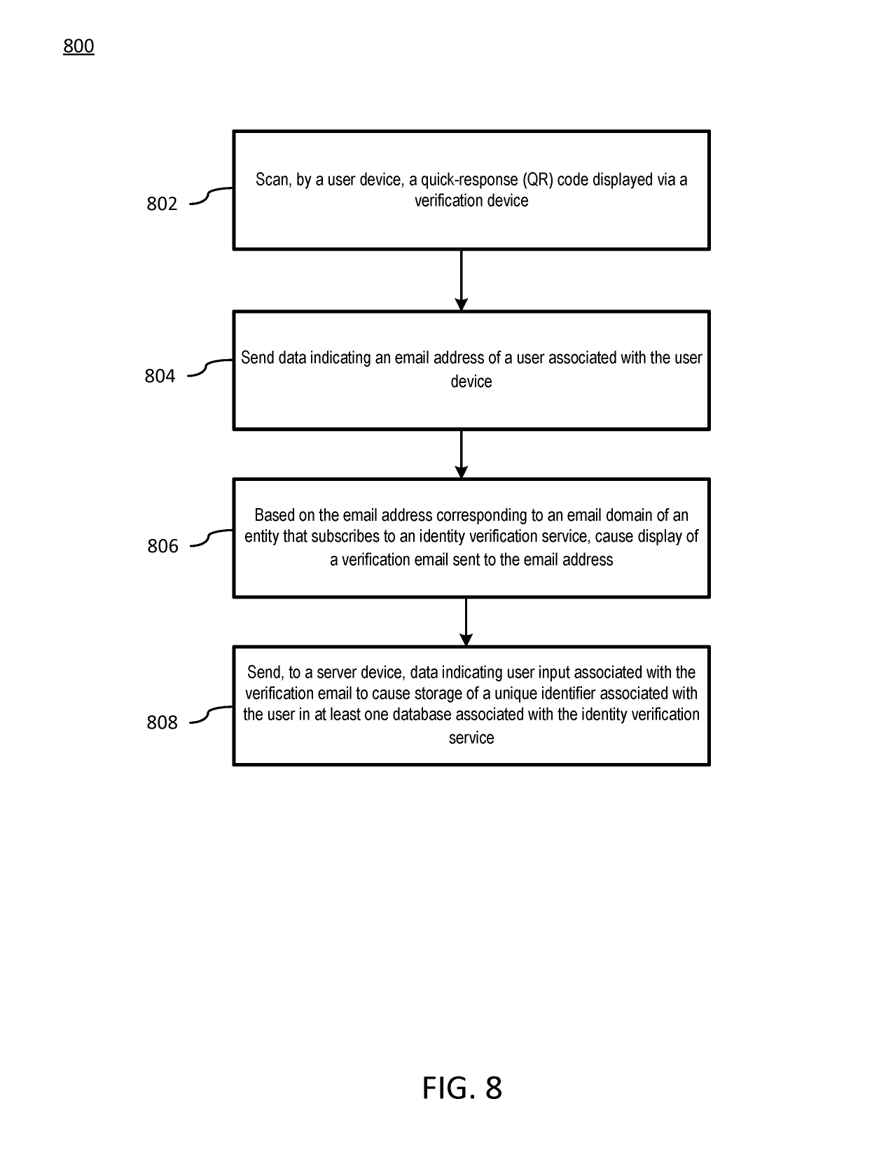

FIG. 8 is an example method 800. The method 800 may comprise a computer implemented method for self verification. A system and/or computing environment, such as the system 100 of FIG. 1 and/or the computing environment of FIG. 8, may be configured to perform the method 800.

A user associated with a user device can self-verify as being associated with an entity that subscribes to the identity verification service. At 802, a user device can scan a quick-response (QR) code displayed via a verification device. As an example, the QR code may be displayed via an application associated with the identity verification service that is executed on (e.g., installed on) the verification device.

Based on (e.g., in response to) the user scanning the QR code, the user can be prompted to enter an email address associated with the user. For example, a prompt to enter the email address can be displayed via an interface of the user device. The user can enter information his or her email address. At 804, data indicating the email address of the user can be sent, such as to a server associated with the identity verifications service. The server can determine if the email address corresponds to an email domain of the entity. If the email address corresponds to an email domain of the entity, the server can send a verification email to the email address.

At 806, display of the verification email sent to the email address can be caused. The verification email can include one or more interface elements that are selectable to verify the email address. The user can interact with (e.g., select) the interface element(s). For example, the user can click a “verify” button and/or can provide information indicating a unique entity identifier, such as a unique identification code (e.g., alphanumeric code, etc.) and/or unique facial feature data (e.g., one or more photos), associated with the user.

At 808, data indicating user input associated with the verification email can be sent. The data indicating the user input associated with the verification email can be sent to the server to cause storage of a unique identifier associated with the user in at least one database associated with the identity verification service. For example, based on (e.g., in response to) receiving the data indicating the user interaction with the verification email, the server can add a unique identifier, such as a unique identification code (e.g., alphanumeric code, etc.) and/or unique facial feature data (e.g., one or more photos), associated with the user to the verified identifier data.

FIG. 9 depicts a computing device that may be used in various aspects, such as the devices and/or components depicted in FIG. 1. With regard to the example architecture of FIG. 1, any of the components may each be implemented in an instance of a computing device 900 of FIG. 9. The computer architecture shown in FIG. 9 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 7 or 8.

The computer system (system) includes one or more processors (e.g., 902, 904, and 906). The processors 902-906 may include one or more internal levels of cache (not shown) and a bus controller 922 or bus interface unit to direct interaction with a processor bus 912. The processor bus 912, also known as the host bus or the front side bus, may be used to couple the processors 902-906 with a system interface 914. The system interface 914 may be connected to the processor bus 912 to interface other components of the system 900 with the processor bus 912. For example, the system interface 914 may include a memory controller 918 for interfacing a main memory 916 with the processor bus 912. The main memory 916 typically includes one or more memory cards and a control circuit (not shown). System interface 914 may also include an input/output (I/O) interface 920 to interface one or more I/O bridges (e.g., I/O bridge 924) or I/O devices with the processor bus 912. One or more I/O controllers and/or I/O devices may be connected with the I/O bus 926, such as I/O controller 928 and I/O device 930, as illustrated.

I/O device 930 may also include an input device (not shown), such as an alphanumeric input device, including alphanumeric and other keys for communicating information and/or command selections to the processors 902-906. Another type of user input device includes cursor control, such as a mouse, a trackball, or cursor direction keys for communicating direction information and command selections to the processors 902-906 and for controlling cursor movement on the display device.

System 900 may include a dynamic storage device, referred to as main memory 916, or a random access memory (RAM) or other computer-readable devices coupled to the processor bus 912 for storing information and instructions to be executed by the processors 902-906. Main memory 916 also may be used for storing temporary variables or other intermediate information during execution of instructions by the processors 902-906. System 900 may include a read only memory (ROM) and/or other static storage device coupled to the processor bus 912 for storing static information and instructions for the processors 902-906. The system set forth in FIG. 9 is but one possible example of a computer system that may employ or be configured in accordance with aspects of the present disclosure.

According to one embodiment, the above techniques may be performed by computer system 900 in response to processor 904 executing one or more sequences of one or more instructions contained in main memory 916. These instructions may be read into main memory 916 from another machine-readable medium, such as a storage device. Execution of the sequences of instructions contained in main memory 916 may cause processors 902-906 to perform the process steps described herein. In alternative embodiments, circuitry may be used in place of or in combination with the software instructions. Thus, embodiments of the present disclosure may include both hardware and software components.

A machine-readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 916. Common forms of machine-readable medium may include, but is not limited to, magnetic storage medium; optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the subject technology may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, from a verification device and by at least one server associated with an identity verification service, encoded data indicative of a unique identifier corresponding to a user;
based on decoding the encoded data, comparing the unique identifier corresponding to the user to a plurality of verified identifiers stored in at least one database, wherein the plurality of verified identifiers are associated with at least one entity, and wherein at least a subset of the plurality of verified identifiers are stored in the at least one database in response to the at least one entity subscribing to the identity verification service; and
causing display, via an interface of the verification device, of a message indicating that an identity of the user is verified in response to determining that the unique identifier matches a verified identifier of the plurality of verified identifiers stored in the at least one database.

2. The method of claim 1, wherein receiving the encoded data indicative of the unique identifier corresponding to the user comprises receiving the encoded data from an application executing on the verification device, wherein the application is associated with the identity verification service.

3. The method of claim 2, wherein the encoded data is stored on a Near Field Communication (NFC) card or an NFC pass, and wherein the application is configured to read the encoded data stored on the NFC card or the NFC pass and send the encoded data to the at least one server.

4. The method of claim 1, wherein causing display of the message indicating that the identity of the user is verified comprises sending data, to the verification device, indicating that the identity of the user is verified.

5. The method of claim 1, wherein causing display of the message indicating that the identity of the user is verified comprises causing display of at least one of: an image of the user, or information indicating a title of the user within the at least one entity.

6. The method of claim 1, wherein the verification device is located at a premises, and wherein the encoded data indicative of the unique identifier is received at a time, the method further comprising:
creating a digital log in the at least one database indicating that the user is located at the premises at the time in response to determining that the unique identifier matches the verified identifier.

7. The method of claim 6, further comprising:
causing display, via an interface of at least one computing device, of information associated with the digital log, wherein the at least one computing device is associated with a privileged user associated with the entity.

8. The method of claim 6, further comprising:
based on determining that the unique identifier matches the verified identifier, causing display, via the interface of the verification device, of at least one user interface element that is selectable to provide additional information about the user;
based on user selection of the at least one user interface element, receiving the additional information about the user; and
causing storage of the additional information about the user in the digital log.

9. The method of claim 1, further comprising:
receiving rule data based on the at least one entity subscribing to the identity verification service, wherein the rule data indicates, for each of the plurality of verified identifiers, one or more corresponding authorized locations.

10. The method of claim 9, wherein the verification device is located at a premises, and wherein determining that the unique identifier matches the verified identifier comprises:
determining, based on the rule data, that the one or more authorized locations corresponding to the verified identifier comprise the premises.

11. The method of claim 1, further comprising:
receiving, from a user device associated with the user, data indicating an email address of the user; and
based on determining that the email address corresponds to an email domain of the at least one entity, sending a verification email to the email address.

12. The method of claim 11, wherein the data indicating the email address of the user is received based on the user device scanning a quick-response (QR) code displayed via the verification device.

13. The method of claim 11, further comprising:
receiving, from the user device, data indicating user input associated with the verification email; and
based on receiving the data indicating the user input, adding the unique identifier as the verified identifier to the at least one database.

14. The method of claim 1, wherein the unique identifier comprises at least one of an alphanumeric code corresponding to the user or data indicating facial features of the user.

15. The method of claim 1, wherein each of the plurality of verified identifiers stored in at least one database comprises at least one of a unique alphanumeric code or facial feature data unique to one of a plurality of users.

16. The method of claim 1, wherein the verification device comprises one or more of a computer, a laptop, a mobile device, a smart phone, a tablet computer, or a wearable computing device.

17. The method of claim 1, wherein the at least one entity comprises one or more of a governmental entity, a business, a non-profit or for-profit organization, or an institution.

18. A server device comprising:
one or more processors; and
memory storing instructions that, when executed by the one or more processors, cause the server device to perform operations comprising:
receiving, from a verification device, encoded data indicative of a unique identifier corresponding to a user;
based on decoding the encoded data, comparing the unique identifier corresponding to the user to a plurality of verified identifiers stored in at least one database, wherein the plurality of verified identifiers are associated with at least one entity, and wherein at least a subset of the plurality of verified identifiers are stored in the at least one database in response to the at least one entity subscribing to an identity verification service; and
causing display, via an interface of the verification device, of a message indicating that an identity of the user is verified in response to determining that the unique identifier matches a verified identifier of the plurality of verified identifiers stored in the at least one database.

19. The method of claim 1, wherein receiving the encoded data indicative of the unique identifier corresponding to the user comprises receiving the encoded data from an application executing on the verification device, wherein the application is associated with the identity verification service.

20. A non-transitory computer-readable medium storing instructions that, when executed, cause:
receiving, from a verification device and by at least one server associated with an identity verification service, encoded data indicative of a unique identifier corresponding to a user;
based on decoding the encoded data, comparing the unique identifier corresponding to the user to a plurality of verified identifiers stored in at least one database, wherein the plurality of verified identifiers are associated with at least one entity, and wherein at least a subset of the plurality of verified identifiers are stored in the at least one database in response to the at least one entity subscribing to the identity verification service; and
causing display, via an interface of the verification device, of a message indicating that an identity of the user is verified in response to determining that the unique identifier matches a verified identifier of the plurality of verified identifiers stored in the at least one database.
